(19) United States
(12) Patent Application Publication
(10) Pub. No.: US 2012/0050466 A1
(43) Pub. Date: Mar. 1, 2012

(54) TRANSMISSION SYSTEM

(76) Inventors: Mitsuhiro Okada, Yokohama (JP); Nobuaki Kabuto, Kunitachi (JP); Hironori Komi, Tokyo (JP)

(21) Appl. No.: 13/164,435

(22) Filed: Jun. 20, 2011

(30) Foreign Application Priority Data
Aug. 30, 2010 (JP) 2010-191637

(51) Int. Cl. H04N 13/00

(52) U.S. Cl. 348/43; 348/E13.001

(57) ABSTRACT

In a method of simultaneously transmitting a plurality of uncompressed video signals, when transmitting different video signals for the right eye and the left eye using a 3D video signal transmission format, information representing that a plurality of video signals are being transmitted is added to a packet of additional information related to the video signals. A transmission method of audio signals at the time of simultaneously transmitting a plurality of video signals is provided. Further, the present invention is consistency with 3D video signal transmission in which two video signals for the right eye and the left eye are transmitted.

### INCORPORATION BY REFERENCE

This application relates to and claims priority from Japanese Patent Application No. 2010-191637 filed on Aug. 30, 2010, the entire disclosure of which is incorporated herein by reference.

### BACKGROUND OF THE INVENTION

(1) Field of the Invention

The technical field of the present invention relates to transmission of video signals and the like among a plurality of devices.

(2) Description of the Related Art

Recently, with the popularization of terrestrial digital broadcasting or Blu-ray Disc (which is a registered trademark and is also referred to as “BD” in the following description), devices adapted for digital video signals have been widely used. An HDMI (which is an abbreviation of High Definition Multimedia Interface, and a registered trademark of HDMI Licensing, LLC) is known as an interface standard in which a source device (a BD recorder/player, an STB, a game console, a personal computer, or the like) that transmits video signals is connected to a sink device (a digital TV, a display, or the like) that displays the video signals.

The HDMI is an interface specification in which uncompressed (baseband) digital video signals and audio signals are transmitted through one HDMI cable, and is employed by many consumer devices.

Japanese Patent Application Laid-Open No. 2009-100412 describes “a TMDS mixing circuit 110 and a TMDS separating circuit 310 are provided, so that TMDS data of video signals of a plurality of channels are transmitted at a frequency higher than the transmission rate of the video signals in a time-division manner. Accordingly, the video signals of a plurality of channels can be transmitted using inexpensive connectors 111 and 311 and cable 201 of type A (see the abstract)” in order to solve a problem “when video signals of a plurality of channels are to be transmitted using an HDMI interface, it is necessary to use a plurality of connectors and cables, or to use expensive connectors and cables of type B, and, in addition, it is difficult to transmit video signals of three or more channels (see the abstract)”.

In “High-Definition Multimedia Interface Specification Version 1.4a Extraction of 3D Signaling Portion” published by HDMI.LLC

(http://www.HDMI.org/manufacturer/specification.aspx), a transmission method of 3D video signals through an HDMI is described.

### SUMMARY OF THE INVENTION

The technical concept of Japanese Patent Application Laid-Open No. 2009-100412 considers no transmission method of audio signals when transmitting a plurality of video signals. Further, the technical concept of Japanese Patent Application Laid-Open No. 2009-100412 considers no consistency with transmission of 3D video signals described in “High-Definition Multimedia Interface Specification Version 1.4a Extraction of 3D Signaling Portion” published by HDMI. LLC.

In order to solve the above-described problem, for example, a configuration described in the scope of claims of the present invention is employed.

The present application includes a plurality of aspects for solving the problem. As an example, a first video signal is transmitted using an area for transmitting a video for the right eye of a 3D video signal transmission format, and a second video signal is transmitted using an area for transmitting a video for the left eye of the 3D video signal transmission format.

Accordingly, the present invention is high in consistency with the 3D video signal transmission method, and a plurality of uncompressed video signals and audio signals can be transmitted using one cable.

### BRIEF DESCRIPTION OF THE DRAWINGS

These and other features, objects and advantages of the present invention will become more apparent from the following description when taken in conjunction with the accompanying drawings wherein:

FIG. 1 shows an example of a configuration of devices in an embodiment;

FIG. 2 shows an example of a configuration of the devices in the embodiment;

FIG. 3 shows an example of a configuration of the devices in the embodiment;

FIG. 4 shows an example of a signal transmission format;

FIG. 5 shows an example of the signal transmission format;

FIG. 6 shows an example of EDID representing the reception capability of a sink device;

FIG. 7 is a diagram for showing an example of a process in the embodiment;

FIG. 8 shows an example of the signal transmission format;

FIG. 9 shows an example of the signal transmission format;

FIG. 10 shows an example of an audio packet;

FIG. 11 is a diagram for showing an example of a relation between an audio packet and a channel;

FIG. 12 shows an example of the signal transmission format;

FIG. 13 shows an example of the signal transmission format;

FIG. 14 is a diagram for showing an example of a process in the embodiment;

FIG. 15 is a diagram for showing an example of screen display;

FIG. 16 is a diagram for showing an example of a process in the embodiment;

FIG. 17 is a diagram for showing an example of screen display;

FIG. 18 is a diagram for showing an example of operations of shutter glasses;

FIG. 19 is a diagram for showing an example of operations of the shutter glasses;

FIG. 20 is a diagram for showing an example of a process in the embodiment; and

FIG. 21 shows an example of “Multi Channel Format”.

### DETAILED DESCRIPTION OF THE EMBODIMENT

Hereinafter, embodiments will be described using the drawings. In the following embodiments, 3D means three dimensions, and 2D means two dimensions. For example, a 3D video means a video which allows a viewer to three-dimensionally perceive an object as if the object exists in the same space where the viewer is located by presenting a video with parallax to the right and left eyes of the viewer. Further, a 3D video signal transmission format is a format in which a video signal enabling display of the 3D video is transmitted through an interface such as an HDMI. The video signal enabling display of the 3D video includes at least two videos (a video for the right eye and a video for the left eye).

Methods of displaying the 3D video include an anaglyph method, a polarization display method, a frame sequential method, a parallax barrier method, a lenticular lens method, a microlens array method, an integral imaging method, and the like.

The anaglyph method is a method in which videos taken from left and right angles are superimposed on red light and blue light to be reproduced, and are viewed using glasses (hereinafter, referred to as “anaglyph glasses”) with red and blue color filters attached on the left and right.

The polarization display method is a method in which left and right videos are superimposed on each other for projection while linear polarized light that is orthogonal to the left and right videos is irradiated thereonto, and are separated using glasses (hereinafter, referred to as “polarization glasses”) with polarization filters.

The frame sequential method is a method in which videos taken from left and right angles are alternately reproduced, and are viewed using glasses (hereinafter, referred to as “shutter glasses”) having liquid crystal shutters that alternately shut left and right views.

The parallax barrier method is a method in which barriers in vertical stripes called “parallax barriers” are superimposed on a display, so that the right eye can see a video for the right eye and the left eye can see a video for the left eye. Thus, it is not necessary for a user to wear special glasses. The parallax barrier method can be further classified into a two-viewpoint method in which a viewing position is relatively narrow and a multi-viewpoint method in which a viewing position is relatively wide.

The lenticular lens method is a method in which a lenticular lens is superimposed on a display, so that the right eye can see a video for the right eye and the left eye can see a video for the left eye. Thus, it is not necessary for a user to wear special glasses. The lenticular lens method can be further classified into a two-viewpoint method in which a viewing position is relatively narrow and a multi-viewpoint method in which a viewing position is relatively wide in the left and right directions.

The microlens array method is a method in which a microlens array is superimposed on a display, so that the right eye can see a video for the right eye and the left eye can see a video for the left eye. Thus, it is not necessary for a user to wear special glasses. The microlens array method is a multi-viewpoint method in which a viewing position is relatively wide in the upper, lower, left and right directions.

The integral imaging method is a method in which a ray wavefront is reproduced so as to present parallax images to a viewer. Thus, it is not necessary for a user to wear special glasses. Further, a viewing position is relatively wide.

It should be noted that the above-described 3D video display methods are examples, and other methods may be employed. In addition, tools and equipment such as the anaglyph glasses, the polarization glasses, and the shutter glasses necessary for viewing 3D videos are collectively referred to as 3D glasses, 3D-viewing equipment, or 3D-viewing aids.

### First Embodiment

In the embodiment, there will be described an example in which a plurality of different video signals and audio signals (hereinafter, a plurality of video signals and audio signals are referred to as multi-channel video signals) are transmitted using a 3D video signal transmission format through one HDMI cable.

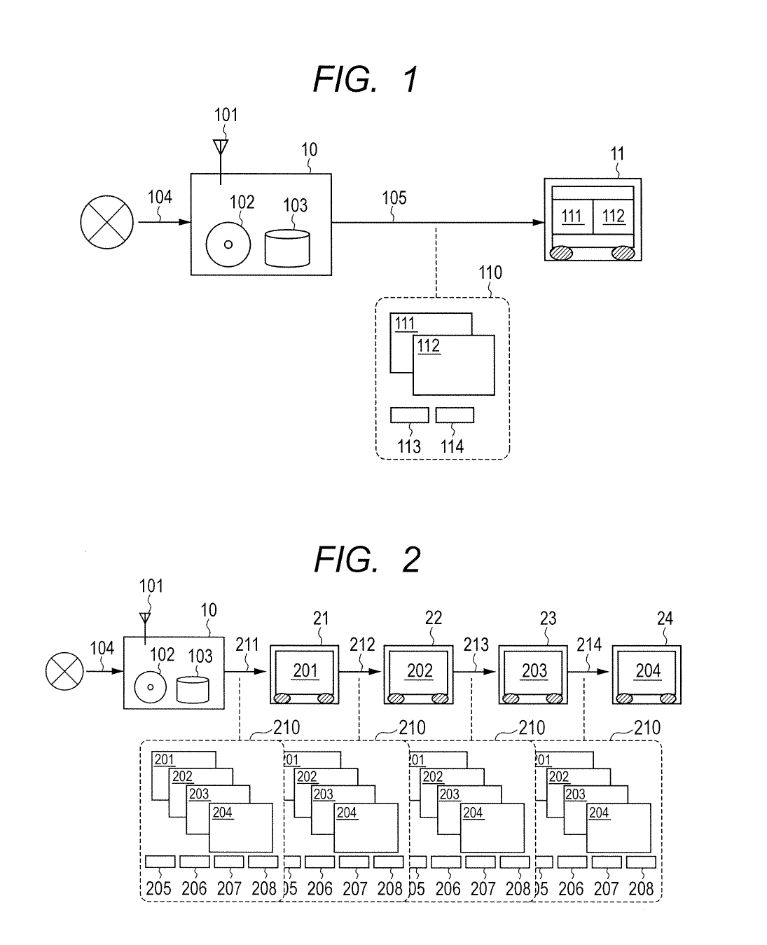

FIG. 1 shows an example in which videos are displayed on a double-screen of a sink device such as a TV. The reference numeral 10 denotes a source device; 101, a tuner; 102, an external recording medium such as a BD, a DVD, a memory card, and an external HDD (Hard Disk Drive); 103, a built-in recording medium such as an HDD; 104, a stream distributed via a network such as Ethernet (registered trademark); 105, an HDMI cable; and 11, a sink device.

The source device 10 demodulates two input streams (streams of land broadcasts, BS, or CS received by the tuner 101, streams read from the external recording medium 102 and the built-in recording medium 103, or streams received via an network) to create the multi-channel video signals.

Further, the multi-channel video signals having different content are transmitted using one HDMI cable 105. The reference numeral 110 denotes an audio packet obtained by converting video signals and audio signals being transmitted into a packet. Here, video signals 111 and 112 of 2 channels, an audio packet 113 of the video signal 111, and an audio packet 114 of the video signal 112 are transmitted. The sink device 11 displays the transmitted video signals 111 and 112 of 2 channels on the screen, and either of the audio packets 113 and 114 is reproduced.

In the case of the example of FIG. 1, two HDMI cables are necessary according to the HDMI standard described in “High-Definition Multimedia Interface Specification Version 1.4a Extraction of 3D Signaling Portion” published by HDMI. LLC. However, transmission of different video signals using the 3D video signal transmission format (for example, transmission of the video signal 111 as a video signal for the right eye and transmission of the video signal 112 as a video signal for the left eye) is high in consistency with the 3D video signal transmission format, and the multi-channel video signals can be transmitted through one HDMI cable.

Accordingly, users can enjoy low costs because only one cable and one connector are necessary. In addition, time and efforts required for connecting the devices to each other through the HDMI cable can be reduced. In the above-described description, either of the audio packets is reproduced. However, since the both audio packets are transmitted to the sink device, it is not necessary to request the source device to switch the audio when the audio is switched by the sink device, leading to fast audio switching.

In the example of FIG. 1, the video signals of 2 channels and the audio packets attached to the video signals are transmitted using the HDMI cable 105. However, in the case where only one of the audio packets is reproduced by the sink device 11 as described above, only one audio packet attached to either of the video signals may be transmitted.

However, in the case where only one audio packet is transmitted, it is necessary to request the source device to switch the audio when switching the audio. Thus, it takes time to switch the audio packet. Further, the double-screen display is exemplified in the example of FIG. 1. However, PinP (Picture in Picture) display may be employed.

FIG. 2 shows an example in which devices are connected to each other by a daisy chain method (wiring method in which a plurality of devices is connected like beads). The source device 10 is operated similar to FIG. 1. Thus, the same reference numerals are given, and the explanations thereof will not be repeated. The reference numerals 21, 22, 23, and 24 denote sink devices which are connected to each other using one HDMI cable 211 to 214.

The reference numeral 210 denotes video signals and audio packets being transmitted in which video signals of 4 channels and corresponding audio packets are being transmitted. Here, video signals 201, 202, 203, and 204 are associated with audio packets 205, 206, 207, and 208, respectively.

Further, each of the sink devices 21 to 23 has a repeater function. The received video signals and audio packets are transmitted to the next sink device as they are, and only the necessary video signals and audio packets are reproduced. As described above, the connection by the daisy chain method through the HDMI cable allows a user to select and view a desired video among the four channels being transmitted by the sink devices. This scheme can be used in the case where, for example, a preferred program is viewed on a monitor of a seat in an airplane.

The example of FIG. 2 can be realized in accordance with the HDMI standard described in “High-Definition Multimedia Interface Specification Version 1.4a Extraction of 3D Signaling Portion” published by HDMI. LLC, while connecting the source device to the sink device on a one-on-one basis. However, every time the channel is changed by the sink device, the source device needs to respond to it. Thus, in the case of four or more sink devices, the source device is disadvantageously required to have a high performance.

However, video signals of 4 channels are transmitted in advance even in the case of four or more sink devices in the example of FIG. 2, and thus it is only necessary for the source device to have specifications in which video signals of 4 channels and audio packets can be transmitted, and the scheme can be realized at low costs.

In addition, the total length of the HDMI cable can be shortened as compared to connecting the source device to the sink devices through different HDMI cables. Further, it is not necessary to request the source device to switch the channel when switching the channel, and thus the channel can be swiftly switched.

As another usage example of FIG. 2, the respective sink devices can request the source device to transmit desired videos. For example, in the case where the sink device 21 is assumed as a TV in a living room and the other sink devices 22 and 23 are assumed as TVs in bed rooms, it is preliminarily determined that the video signal 201 is displayed on the sink device 21 and the video signal 202 is displayed on the sink device 22. Thus, the respective sink devices can request the source device to transmit desired videos. In this case, too, the total length of the HDMI cable can be shortened as compared to connecting the source device to the respective sink devices through different cables.

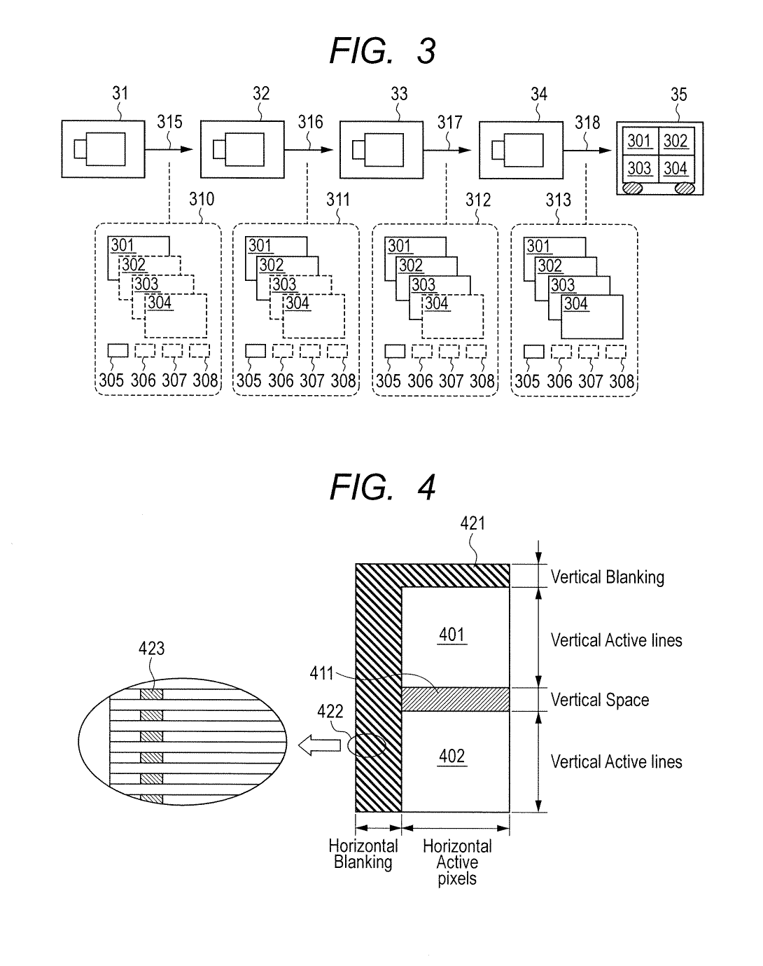

FIG. 3 shows an example in which a plurality of source devices is connected to each other by the daisy chain method. The reference numerals 31 to 34 denote source devices, and the reference numeral 35 denotes a sink device. The devices are connected to each other using HDMI cables 315 to 318.

The reference numerals 310 to 313 denote video signals and audio packets being transmitted through the HDMI cables 315 to 318. Further, the reference numerals 301 to 304 denote video signals, and 305 to 308 denote audio packets. Here, the video signals 301, 302, 303, and 304 are associated with the audio packets 305, 306, 307, and 308, respectively.

Further, the video signals and audio packets represented by dotted lines show inactive signals that transmit no information. The source device 31 transmits the video signal 301 and the audio packet 305 to the HDMI cable 315. The source device 32 transmits the video signal 302 and the audio packet 306 to the HDMI cable 316, in addition to the video signal 301 and the audio packet 305 received from the source device 31. The source device 33 similarly transmits the video signal 303 and the audio packet 207 to the HDMI cable 317, in addition to the signals transmitted from the source device 32. Further, the source device 34 similarly transmits the video signal 304 and the audio packet 308 to the HDMI cable 318, in addition to the signals transmitted from the source device 33. The sink device 35 displays the received video signals 301 to 304 on one screen while being divided into four.

As described above, it is possible to increase the number of channels to be transmitted using not one source device but a plurality of source devices through the HDMI cable capable of transmitting the multi-channel video signals.

This scheme is effective in the case where, for example, a decoding capability of one source device is insufficient. Further, this scheme is also effective in the case where desired content to be reproduced is contained in internal recording media of a plurality of source devices. Further, this scheme is also effective in the case where videos taken from a plurality of cameras are integrated into one for a TV conference.

It should be noted that three examples have been described above, but the present invention is not limited to these examples. For example, the source device of FIG. 2 may be replaced by those of FIG. 3. In addition, the video displayed on the sink device 21 of FIG. 2 may be displayed on a double-screen as 201 and 202 of FIG. 1.

Next, there will be described a concrete transmission method of realizing transmission of the multi-channel video signals using the 3D video signal transmission format described in the HDMI standard of “High-Definition Multimedia Interface Specification Version 1.4a Extraction of 3D Signaling Portion” published by HDMI. LLC.

FIG. 4 shows an example of the 3D video signal transmission format. The reference numerals 401 and 402 denote Active Video periods during which video signals are transmitted. The 3D video signal transmission format allows a video for the left eye and a video for the right eye to be transmitted during the Active Video periods 401 and 402, respectively.

The reference numeral 411 denotes an Active Space period that is not for the video signal.

The reference numeral 421 denotes a blanking period during which audio signals and additional information are transmitted in a packet format. The reference numeral 423 denotes an audio packet obtained by converting audio signals into a packet, and a part 422 of the blanking period is displayed while being enlarged.

In the embodiment, instead of the 3D video signals, different video signals are transmitted during the Active Video periods 401 and 402 using the 3D video signal transmission format of FIG. 4, so that different two video signals can be transmitted. Specifically, the transmission period for video signals is divided, and different video signals are transmitted using the divided transmission periods for video signals.

However, if the sink device cannot discriminate that different video signals are being transmitted using the 3D video signal transmission format, there is a problem that the sink device displays the signals as 3D video signals.

In order to solve the problem, new flags are defined in VSIF (Vender-Specific InfoFrame) representing additional information related to video signals and EDID (Extended Display Identification Data) representing the reception capability of the sink device.

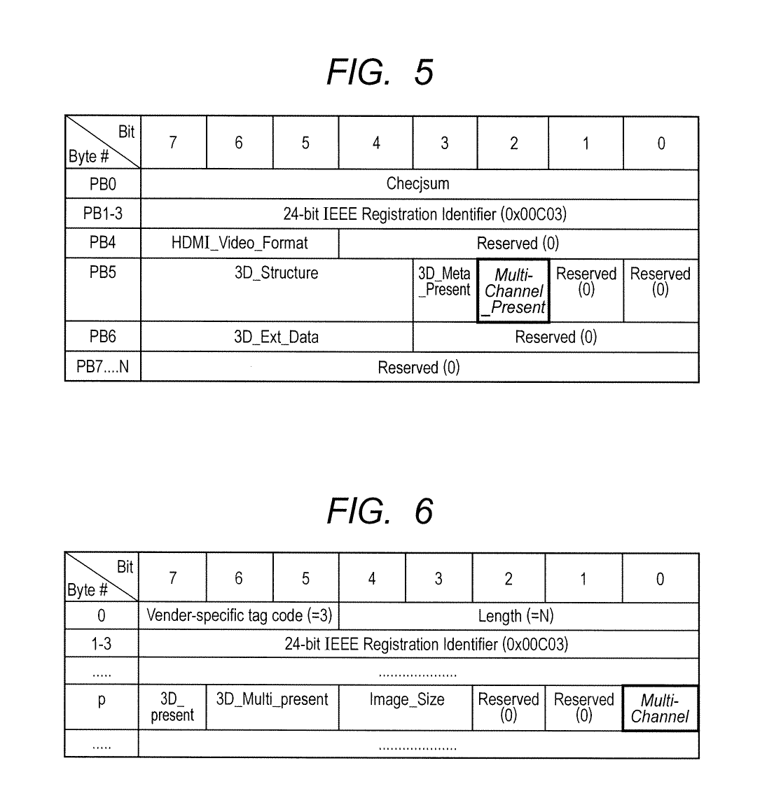

FIG. 5 shows a table obtained by extracting a part of the VSIF of the 3D video signal transmission format. The vertical axis represents bytes, and the horizontal axis represents bits. The table shows what information each bit represents. Further, “Multi_Channel_Present” shown by a thick frame is the bit of Reserved (0) that is not used in the HDMI standard described in “High-Definition Multimedia Interface Specification Version 1.4a Extraction of 3D Signaling Portion” published by HDMI. LLC, and is newly defined in the embodiment.

When “Multi_Channel_Present” is “1”, it means that the multi-channel video signals are being transmitted. On the other hand, when “Multi_Channel_Present” is “0”, it means that the 3D video signals are being transmitted.

FIG. 6 shows a table obtained by extracting a part of the EDID representing the capability of the sink device. The vertical axis represents bytes, and the horizontal axis represents bits. The table shows what information each bit represents. Further, “Multi_Channel” shown by a thick frame is the bit of Reserved (0) that is not used in the HDMI standard described in “High-Definition Multimedia Interface Specification Version 1.4a Extraction of 3D Signaling Portion” published by HDMI. LLC, and is newly defined in the embodiment.

When “3D_present” and “Multi_Channel” are both “1”, it means that the 3D video signals and the multi-channel video signals can be handled. When the former is “1” and the latter is “0”, it means that only the 3D video signals can be handled. When the former is “0” and the latter is “1”, it means that the 3D video signals cannot be handled, but the multi-channel video signals can be handled.

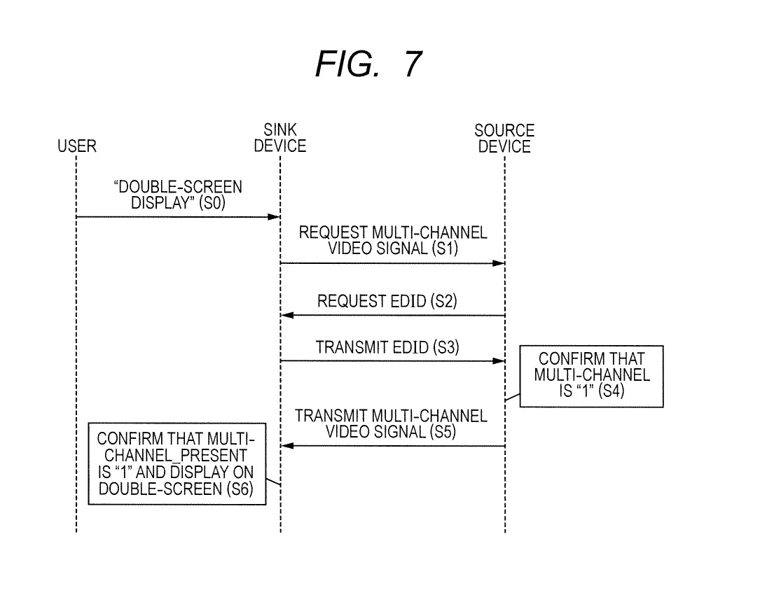

Next, an operation flow of the source device and the sink device that are connected to each other as the example of FIG. 1 will be described using FIG. 7. In the first place, a user looks at the menu display of the source device and selects “double-screen display” at the sink device such as a TV using a remote control or the like (S0).

The sink device that received the request of “double-screen display” requests the source device to transmit the multi-channel video signals using, for example, CEC (Consumer Electronics Control) that is a device cooperative control function of the HDMI (S1).

Next, the source device requests the sink device to transmit the EDID (S2).

Next, the sink device transmits the EDID to the source device (S3). It should be noted that if the source device stores previously-received EDID information, the steps (S2) and (S3) may be skipped using the stored EDID information. The source device that received the EDID confirms that the Multi_Channel flag is “1” (S4).

If “Multi_Channel” is “1”, the source device sets “Multi_Channel_Present” of the VSIF at “1” to start transmitting the multi-channel video signals (S5). The sink device that received the multi-channel video signals confirms the Multi_Channel_Present flag. When the Multi_Channel_Present flag is “1”, two different video signals are displayed on the double-screen (S6).

It should be noted that a plurality of sink devices are connected to each other by the daisy chain method as shown in FIG. 2, the EDID is repeated by the repeaters, so that this flow can be handled by the plurality of sink devices that are connected to each other.

As described above, the flag indicating that the multi-channel video signals can be received is newly defined in the EDID, and the flag indicating that the multi-channel video signals are being transmitted is newly defined in the VSIF, so that video signals of 2 channels can be transmitted using the 3D video signal transmission format.

It should be noted that a filling signal using a predetermined RGB pattern or a predetermined neutral color indicating that the multi-channel video signals are being transmitted may be transmitted during the Active Space period, instead of defining the flag representing the multi-channel in the VSIF. In this case, even if the VSIF cannot be transmitted because a repeater that is not adapted for the multi-channel video signals is arranged in the middle, the multi-channel video signals can be discriminated.

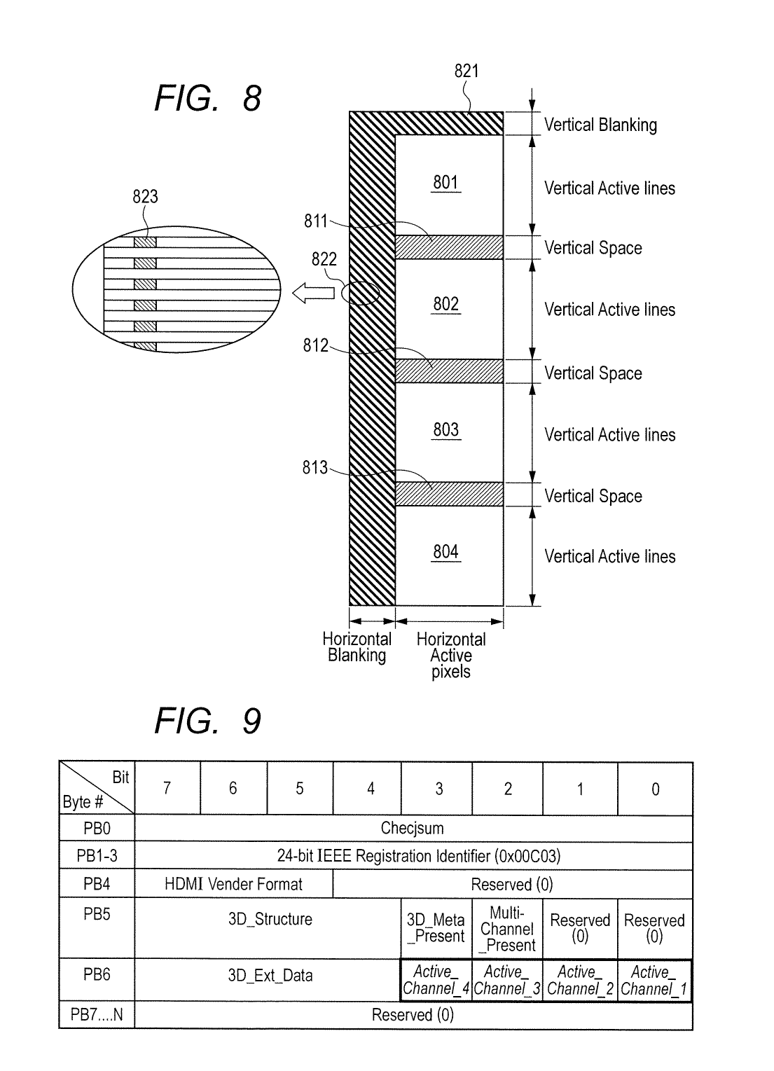

FIG. 8 shows another example of the 3D video signal transmission format. The reference numerals 801 to 804 denote Active Video periods. The 3D video signal transmission format allows a video for the left eye, depth information of the video for the left eye, a graphic video, and depth information of the graphic video to be transmitted during the Active Video periods 801, 802, 803, and 804, respectively.

The reference numerals 811 to 813 denote Active Space periods during which no video signals are transmitted. The reference numeral 821 denotes a blanking period during which audio signals and additional information are transmitted in a packet format. The reference numeral 823 denotes an audio packet, and a part 822 of the blanking period is displayed while being enlarged.

In the 3D video signal transmission format of FIG. 5, only two different video signals can be transmitted. However, four different video signals can be transmitted by using the 3D video signal transmission format of FIG. 8.

FIG. 9 shows an example in which a flag indicating the presence or absence of transmission of each video signal is added to the VSIF of the 3D video signals. If there are channels which transmit no video signals as the cables 315, 316, and 317 of FIG. 3, and if video signals of 3 channels are to be transmitted using the 3D video signal transmission format of FIG. 8, a flag indicating the presence or absence of the video signals is necessary.

Therefore, 4-bit flags of Active_Channel_1 to Active_Channel_4 surrounded by thick lines of FIG. 9 are defined. The flags are associated with the Active Video periods 801 to 804 of FIG. 8, and indicate the presence or absence of videos. Specifically, The Active Video period 801 is associated with Active_Channel_1; the Active Video period 802, Active_Channel_2; the Active Video period 803, Active_Channel_3; and the Active Video period 804, Active_Channel_4.

As described above, the flags indicating the presence or absence of the video signals are defined, so that an additional video can be reliably inserted into an unused channel as the example of FIG. 3. Further, this scheme can be adapted for the case in which the video signals of 3 channels are transmitted using the 3D video signal transmission format of FIG. 8.

FIG. 9 shows the example in which 4 bits are newly defined and the presence or absence of transmission of the video signals is represented by each bit. However, the number (any one of 0 to 4) of active video signals may be written using 3 bits. 0 represents an inactive video signal, for example, a black screen.

Next, a method of transmitting audio signals in accordance with a plurality of video signals will be described. As the audio signals, stereo audio signals of 4 channels are transmitted using an audio packet capable of transmitting 7.1ch.

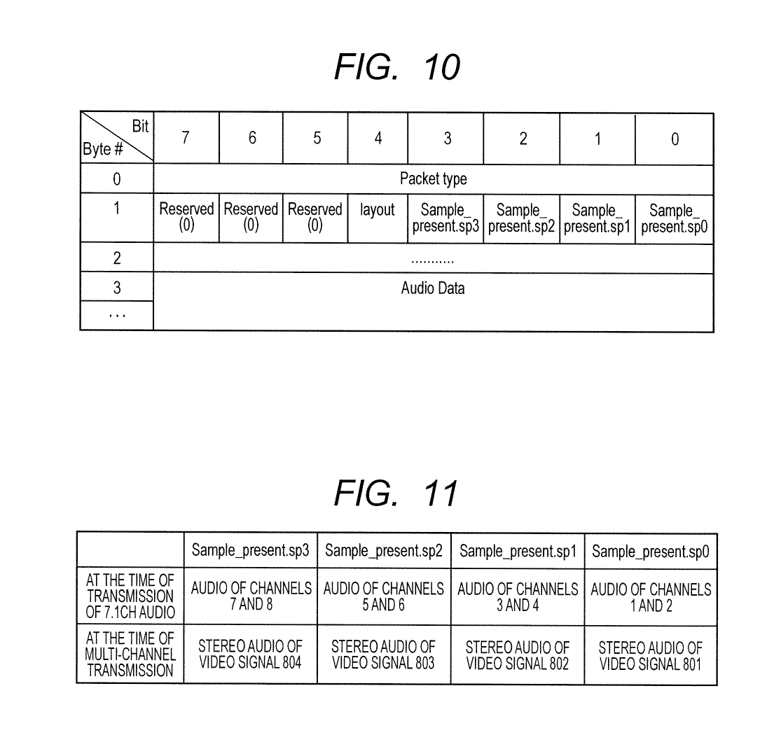

FIG. 10 shows an example of an audio packet. The first 3 bytes represent a header, followed by Audio Data representing audio signals. Stereo audio can be transmitted by one audio packet. When 7.1ch audio signals are transmitted, a flag of Sample_present. spX (X=0 to 3) is used to discriminate to which channel the audio belongs.

Specifically, as shown in the table of FIG. 11, when “Sample_present. sp0” is “1”, the audio signals of channels 1 and 2 are defined; when “Sample_present. sp1” is “1”, the audio signals of channels 3 and 4 are defined; when “Sample_present. sp2” is “1”, the audio signals of channels 5 and 6 are defined; and when “Sample_present. sp3” is “1”, the audio signals of channels 7 and 8 are defined. The flag is exclusive, and only one flag becomes “1”.

On the other hand, at the time of transmitting the multi-channel video signals, when “Sample_present. sp0” is “1”, the audio signal of the video signal 801 of FIG. 8 is defined; when “Sample_present. sp1” is “1”, the audio signal of the video signal 802 of FIG. 8 is defined; when “Sample_present. sp2” is “1”, the audio signal of the video signal 803 of FIG. 8 is defined; and when “Sample_present. sp3” is “1”, the audio signal of the video signal 804 of FIG. 8 is defined, as shown in the table of FIG. 11.

As described above, when the multi-channel video signals are transmitted, the interpretation of the HDMI standard described in “High-Definition Multimedia Interface Specification Version 1.4a Extraction of 3D Signaling Portion” published by HDMI. LLC is only changed, so that new information does not need to be defined, and stereo audio of up to 4 channels can be transmitted.

In the embodiment, the flag indicating that the multi-channel video signals can be received is only defined in the information representing the reception capability of the sink device, and the flag indicating that the multi-channel video signals are being transmitted is only added to and defined in the packet of additional information at the time of transmitting the multi-channel video signals. Thus, this scheme is high in consistency with the 3D video signal transmission format, and video signals and audio signals of 2 or 4 channels can be transmitted. Further, video signals and audio signals of 3 channels can be transmitted by defining the flag indicating the presence or absence of transmission of the video signals.

### Second Embodiment

In the first embodiment, the method of transmitting video signals of up to 4 channels and stereo audio signals attached to the respective video signals while adding the flags to the VSIF and EDID has been described. However, there is a case of transmitting a plurality of 7.1ch audio signals.

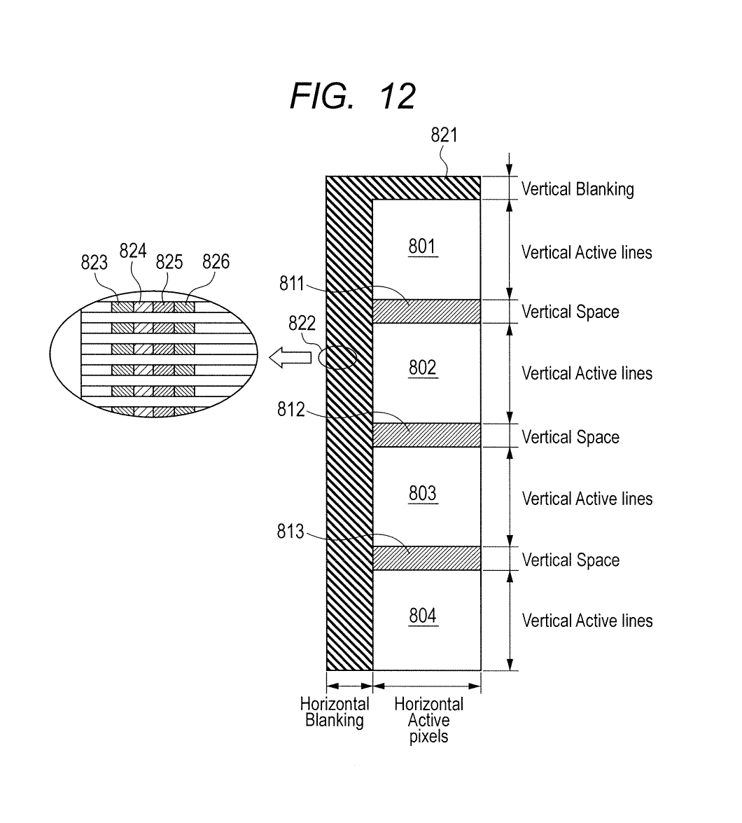

In the embodiment, packet types of audio packets are newly and additionally defined to solve the problem. FIG. 12 shows an example in which a plurality of audio packets is defined in the 3D video signal transmission format of FIG. 8. The same constituent elements as FIG. 8 are given the same reference numerals, and thus explanations thereof will not be repeated.

The reference numerals 824, 825, and 826 denote different packet types of audio packets. Here, the video signals and the audio signals are defined in such a manner that the audio packet 823 is associated with the audio signal of the video signal 801; the audio packet 824, the audio signal of the video signal 802; the audio packet 825, the audio signal of the video signal 803; and the audio packet 826, the audio signal of the video signal 804.

It should be noted that as the packet types, for example, packet types for video multi-channel transmission may be added to and defined in unused packet types in the HDMI standard. It is only necessary to describe to which video channel the data belong, at the header portion of a packet for video multi-channel transmission.

The audio packet is not limited to audio data (Audio Sample), but various audio-related packets such as audio clock information (Audio Clock Regeneration) and audio copyright protection (Audio Content Protection) may be newly defined for video multi-channel transmission.

The packet types of audio packets associated with a plurality of video signals are newly defined as in the embodiment, so that a plurality of 7.1ch audio signals can be transmitted. Further, this scheme can be adapted for the case in which stereo audio signals attached to video signals of 4 or more channels are to be transmitted.

Further, there is a case of appropriately selecting the transmission method of audio packets of the first embodiment or the transmission method of audio packets of the second embodiment. This selection can be made by newly defining information representing in which format the audio packets are being transmitted (for example, by newly defining, in the VSIF, 1-bit Audio_Packet_Type indicating with which format the audio packets are being transmitted.

“Audio_Packet_Type” becomes active when “Multi_Channel_Present” is For example, when “Audio_Packet_Type” is “0”, the transmission method of audio packets of the first embodiment is available. When “Audio_Packet_Type” is “1”, the transmission method of audio packets of the second embodiment is available. Accordingly, the audio packet can be transmitted in accordance with the both transmission methods of audio packets depending on the usage.

Further, 2-bit Multi_Audio indicating which transmission method of audio packets is available may be defined in the EDID representing the reception capability of the sink device. For example, the reception capability is defined in such a manner that: when “Multi_Audio” is “00”, the transmission method of audio packets of the first embodiment is available; “Multi_Audio” is “01”, the transmission method of audio packets of the second embodiment is available; and “Multi_Audio” is “10”, the both transmission methods of audio packets are available. As described above, the audio packets can be transmitted by only one limited transmission method while defining the EDID, and the number of steps required for software implementation can be reduced by implementing only one transmission method.

### Third Embodiment

In the embodiment, there will be described an example in which the Active Video period is divided into plural to transmit a plurality of video signals.

In the first embodiment, there has been described the example in which a plurality of video signals are transmitted using the 3D video signal transmission format. However, a plurality of video signals can be transmitted by dividing the Active Video period for normal 2D video signals into plural.

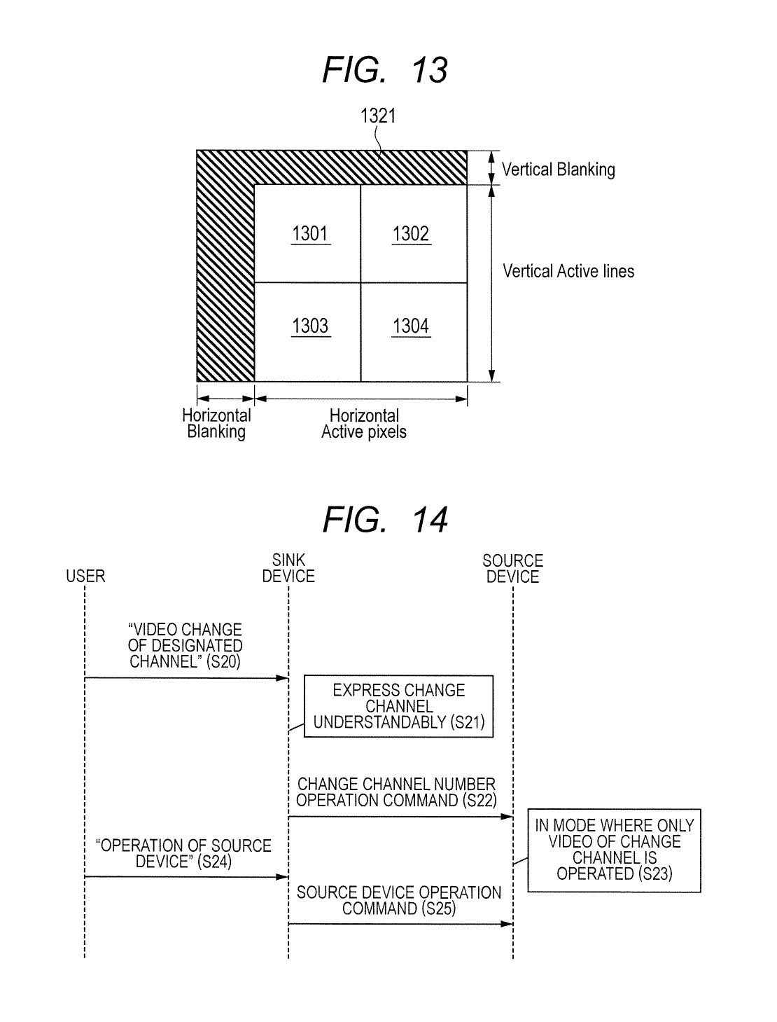

This method will be described in detail using FIG. 13. FIG. 13 shows an example in which the Active Video period for normal 2D video signals is divided into four. The reference numeral 1301 denotes a video signal of channel 1; 1302, a video signal of channel 2; 1303, a video signal of channel 3; 1304, a video signal of channel 3; and 1321, a blanking period.

As described above, the Active Video period for normal 2D video signals is divided into plural, and different video signals are transmitted to the respective channels, so that a plurality of video signals can be transmitted.

In order for the sink device to discriminate that the Active Video period is divided, information representing that the video signals are being transmitted while dividing the screen. For example, “Multi Channel Format” is added to and defined in “HDMI_Video_Format” of the VSIF.

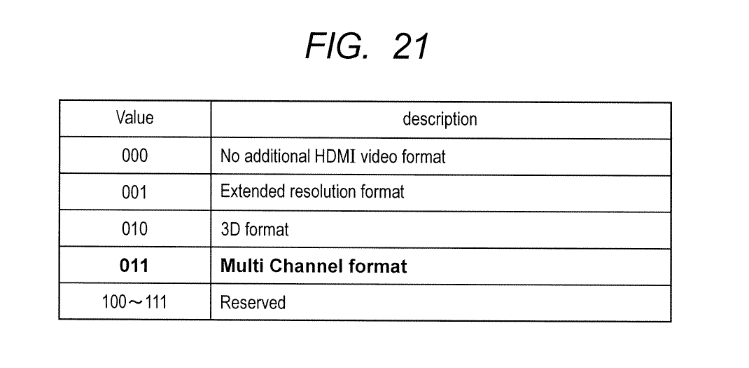

FIG. 21 shows an example in which “Multi Channel Format” is added to “HDMI_Video_Format”. The bold-faced “Multi Channel Format” is newly-defined information. The number of divisions can be set without defining additional information while the number of divisions (four divisions in the case of FIG. 13) is set between the sink device and the source device as shown in, for example, FIG. 13. In the case where the video signals are to be transmitted using an arbitrary number of divisions, 1, as the number of divisions, is added to and defined in the VSIF. Alternatively, 1, as the number of divisions in the vertical direction, and 1, as the number of divisions in the horizontal direction, are added to and defined in the VSIF, so that various numbers of channels can be transmitted.

In the case of the EDID, when “Multi_Channel” of the EDID described in the first embodiment is “1”, the screen division may be available. Further, as another example of the EDID, information regarding to the maximum number of channels may be used, instead of the flag indicating whether or not the screen division is available.

It should be noted that in the case of transmission of video signals of up to 4 channels, the audio may be transmitted in accordance with the transmission method of stereo audio of the first embodiment, and in the case of transmission of video signals of 5 to 8 channels, the audio may be transmitted in accordance with the transmission method of monaural audio. In the case of transmitting 7.1ch audio signals for a plurality of videos and stereo audio for videos of 5 or more channels, the transmission method of audio packets described in the second embodiment is used, and the packet types corresponding to the number of video channels may be added and defined.

As described above, the Active Video period is divided into plural to transmit a plurality of video signals, so that it is not necessary to change the pixel clock. Thus, the video signals can be transmitted using an existing HDMI cable.

Further, although video signals of up to 4 channels can be transmitted in the first embodiment, video signals of 4 or more channels can be transmitted by increasing the number of divisions of the screen or using the divisions of the screen and the 3D video format in combination.

### Fourth Embodiment

In the embodiment, a method of changing an image size will be described. In the video signal transmission methods of the first embodiment and the third embodiment, the image sizes of a plurality of videos cannot be changed. Therefore, a transmission image size is newly defined in the VSIF, so that an arbitrary image size can be transmitted.

The transmission image size may be a common image size among all channels, or an image size may be transmitted for each channel. Further, the transmission image size is set at a value smaller than the division size obtained by evenly dividing the Active Video period of the image format by the number of divisions, and the rest of the period may be used as Active Space.

As described above, the image size information is added at the time of transmission, so that a plurality of video signals with different image sizes can be transmitted.

Further, available image sizes may be defined in the EDID. By defining the image sizes in the EDID and by limiting the image sizes that can be processed, the number of steps required for software implementation can be reduced.

### Fifth Embodiment

In the embodiment, there will be described an application of a CEC (Consumer Electronics Control) command that is a device cooperative function defined in the HDMI in transmission of a plurality of video signals and audio signals described in the first to fourth embodiments.

In the first place, an example of changing a video output from the sink device to the source device will be described using the configuration example of FIG. 1. FIG. 14 shows an operation flow of changing a video output from the sink device to the source device.

A user gives an instruction of “video change of designated channel” to the sink device such as a TV using a remote control or the like (S20). Upon request of “video change of designated channel”, the sink device expresses the designated channel to be changed so as to be understandable by the user (S21).

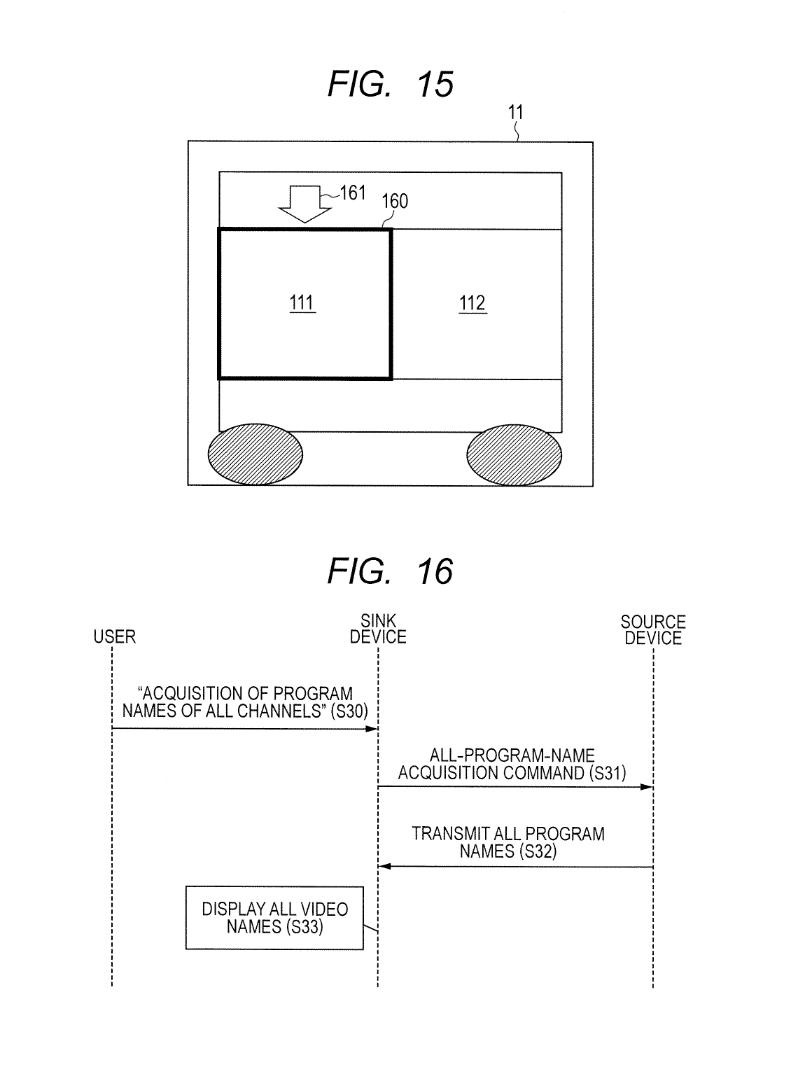

FIG. 15 shows an example in which the channel to be changed of the sink device 11 of FIG. 1 is expressed. In the example, a video 111 of the designated channel is surrounded by a thick frame 160, so that the channel to be changed is expressed. As another example, any display method can be employed as long as the user can recognize the channel to be changed, such as displaying OSD indicating the channel to be changed, as shown by the reference numeral 161. It should be noted that the user can select the channel to be changed using a user interface such as a remote control.

Thereafter, the sink device transmits an operation command for the channel number to be changed to the source device using, for example, the CEC that is a device cooperative control function of the HDMI (S22). On reception of the operation command for the channel number to be changed, the sink device is turned into a mode where the video of the channel to be changed is operated (S23).

Next, the user requests “operation of source device”, such as changing a TV channel or changing reproduced content, using the CEC command as similar to one-screen display (S24). On request of “operation of source device”, the sink device transmits a source device operation command to the source device (S25).

As described above, one of a plurality of channels can be changed by transmitting the operation command for the channel number to be changed using the CEC command.

Next, there will be described a case in which videos of a plurality of channels are transmitted and the user views an arbitrary channel as the configuration example of FIG. 2. In this case, if all program names of channels being transmitted are given, the user does not need to view all the channels for selection, and thus the selection of a channel becomes easy. Therefore, a method of acquiring all program names of channels being transmitted will be described.

FIG. 16 is an operation flow of acquiring all program names. In the first place, the user gives an instruction of “acquisition of program names of all channels” to the sink device such as a TV using a remote control or the like (S30). On reception of “acquisition of program names of all channels”, the sink device transmits a command (all-program-name acquisition command) for requesting the acquisition of all program names to the source device using the CEC (S31).

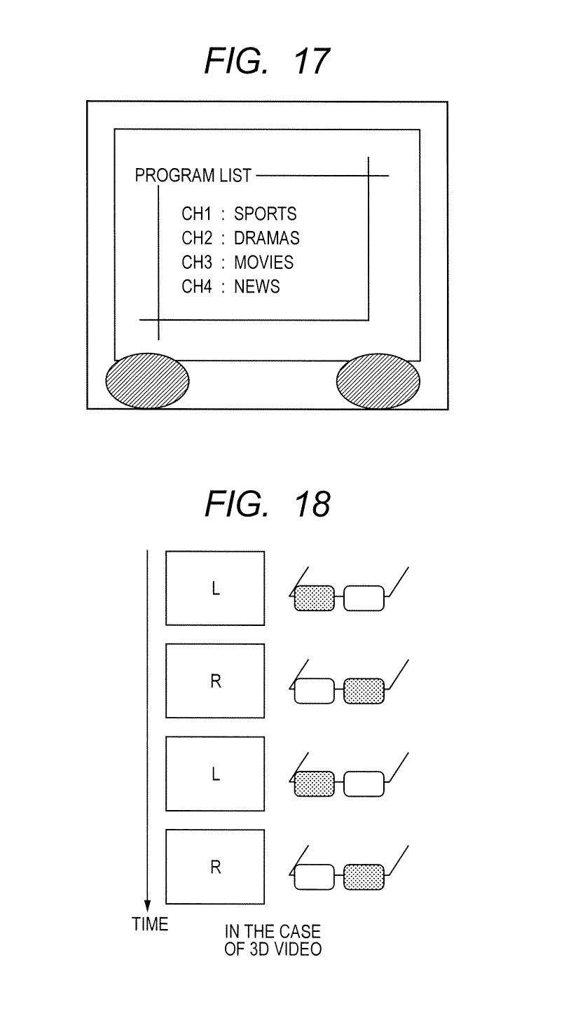

On reception of the all-program-name acquisition command, the source device transmits information of all program names to the sink device (S32). On reception of the information of all program names, the sink device displays the same (S33). FIG. 17 shows a display example of a 4-channel program list. The program list may be displayed on the entire screen as shown in FIG. 17, or may be displayed at a part of the screen.

As described above, the all-program-name acquisition command is newly defined as a CEC command to be transmitted, so that a desired program among a plurality of channels can be selected.

Next, there will be described an example in which a process in cooperation with shutter glasses is performed when 3D videos are viewed using the shutter glasses in the sink device employing the frame sequential method.

FIG. 18 shows an operation of the shutter glasses in the frame sequential method. In the frame sequential method, a video L for the left eye and a video R for the right eye are alternately reproduced, and the videos are accordingly separated with the shutter glasses. The shutter glasses shown on the sides of the videos L and R show operations of the shutter glasses when each video is displayed, the black glasses mean that the videos are shut off. As described above, the shutters are allowed to be alternately opened and closed in synchronization with the videos L and R, so that the videos L and R are separated in the shutter glass method.

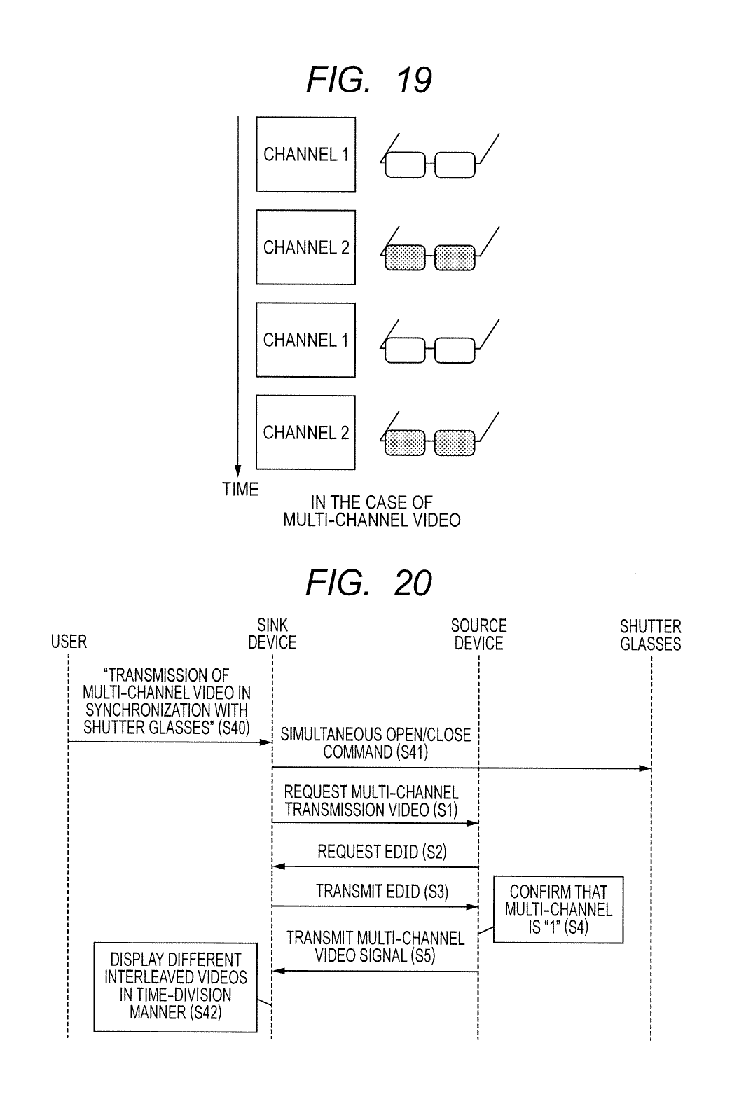

FIG. 19 shows an example of being applied to the multi-channel video signals using the shutter glasses. In the case of the multi-channel video signals, videos of channel 1 and videos of channel 2 are alternately reproduced, instead of the videos L and R. For the 3D videos, the shutter glasses are alternately opened and closed. However, a specific channel can be viewed by simultaneously opening or closing the left and right shutter glasses as shown in FIG. 20. By applying the principle, a plurality of people wearing the shutter glasses can view different videos on one TV.

FIG. 20 shows an operation flow in cooperation with the shutter glasses. In the first place, the user gives an instruction of “transmission of multi-channel video signal in synchronization with shitter glasses” to the sink device such as a TV using a remote control or the like (S40). On request of “transmission of multi-channel video signal in synchronization with shitter glasses”, the sink device transmits a simultaneous open/close command to the shutter glasses (S41). On reception of the simultaneous open/close command, the shutter glasses allow the left and right shutters to be simultaneously opened or closed as shown in the drawing of FIG. 19.

Next, the source device is requested to transmit the multi-channel video signals (S1). The operations in the following steps S2 to S5 are the same as those in FIG. 7, and thus the explanations thereof will not be repeated by giving the same reference numerals. Finally, on reception of the multi-channel video signals, the sink device displays different interleaved videos in a time-division manner (S42).

As described above, the sink device displays the different interleaved videos in a time-division manner, the simultaneous open/close command is newly defined as a CEC command, and the left and right shutters of the shutter glasses are simultaneously opened or closed, so that different videos can be viewed on one TV.

While we have shown and described several embodiments in accordance with our invention, it should be understood that disclosed embodiments are susceptible of changes and modifications without departing from the scope of the invention. Therefore, we do not intend to be bound by the details shown and described herein but intend to cover all such changes and modifications that fall within the ambit of the appended claims.

What is claimed is:

1. A transmission system which transmits a plurality of video signals from a source device to a sink device through an HDMI, wherein
the source device transmits a first video signal using an area for transmitting a video for the right eye of a 3D video signal transmission format, and a second video signal related to content that is different from the first video signal using an area for transmitting a video for the left eye of the 3D video signal transmission format.

2. The transmission system according to claim 1, wherein
the signals transmitted from the source device to the sink device include information indicating that a plurality of video signals are being transmitted, and when receiving the video signals including the information indicating that the plurality of video signals are being transmitted, the sink device displays the plurality of received video signals on divided screens.

3. The transmission system according to claim 1, wherein
the sink device holds information indicating whether or not the plurality of video signals are to be processed,
when receiving a request for transmitting the video signals from the sink device, the source device reads the information indicating whether or not the plurality of video signals are to be processed held by the sink device, and
when the information indicating whether or not the plurality of video signals are to be processed indicates that the plurality of video signals can be processed, the plurality of video signals are transmitted to the sink device.
